(19) United States
(12) Patent Application Publication
(10) Pub. No.: US 2008/0157695 A1
(43) Pub. Date: Jul. 3, 2008

(54) METHOD AND APPARATUS FOR PULSING HIGH POWER LAMPS

(76) Inventor: Robert M. Lantis, Weaverville, NC (US)

Correspondence Address: MILES & STOCKBRIDGE PC, 1751 PINNACLE DRIVE, SUITE 500, MCLEAN, VA, 22102-3833, US

(21) Appl. No.: 11/960,588

(22) Filed: Dec. 19, 2007

Related U.S. Application Data
(60) Provisional application No. 60/870,672, filed on Dec. 19, 2006.

(51) Int. Cl. H05B 41/30

(52) U.S. Cl. 315/246

(57) ABSTRACT

New and advantageous methods related to the design and manufacture of pulsed power systems for a new generation of higher performance flash lamps are disclosed. A reliable and cost-effective pulsed discharge lamp power supply system is provided that promotes PUV lamp efficiency beyond that which is achievable by means of prior art, thereby similarly decreasing the loss factor for both UV radiation and overall electrical energy. Also disclosed is a pulsed discharge lamp power supply system that serves to help prevent lamp envelope fracture and/or light output degradation resulting from the deleterious effects of intense radiation pulses. The pulsed discharge lamp power supply system produces an electrical output that is dynamically impedance-matched with the lamp throughout the entire time span of and the transition sequence between all three operating modes, thereby creating the necessary discharge conditions for optimal lamp operation. For example, the pulsed discharge lamp power supply system produces an ignition mode pulse only when and in the form specifically required for optimal lamp operation; produces a simmer current only when and in the form specifically required for optimal lamp operation; and produces a main discharge current pulse only when and in the temporal-amplitude shape that is specifically required for optimal lamp operation.

### FIELD OF THE INVENTION

The present invention relates to the design and manufacture of pulsed power supply systems for pulsed electric discharge lamps. Specifically, the present invention relates to the design and manufacture of pulsed power systems for a new generation of higher performance flash lamps that produce high average and/or high peak power broadband light, including those intended to produce pulsed ultraviolet (PUV) light.

### BACKGROUND AND SUMMARY OF THE INVENTION

Broadband output high power pulsed flash lamps are useful in many applications, including beacons, communications, imaging, laser pumping, and materials processing. When specifically optimized, they can become an excellent source of ultraviolet (UV) light, which is particularly useful for photo-chemically-induced materials processing applications. Ultraviolet lamps producing high power pulsed ultraviolet (PUV) light can be ideally suitable for use in the decontamination of fluids (particularly water, wastewater, and other liquids, gases and objects), and for other applications such as photo-enhancement of chemical reactions, treatment of light sensitive materials, medical use, and so forth. In many operation scenarios the required pulsed energy transfer (high average and/or peak power) and subsequent thermal effects may create certain detrimental effects, such as reduction of lamp efficiency, changes in lamp spectral output, reduction of the delivered radiation due to fouling of optically transmitting surfaces, damage of lamp components, and reduction of lamp service lifetime. These flash lamp systems require performance and power levels that exceed those of the traditional order. The heretofore known pulsed power supply topologies and resulting operation methods can be problematic and inadequate for meeting increased requirements of the newest generation of high power pulsed flash lamps.

Pulsed discharge lamp systems comprise a pulsed power supply source and an electric discharge lamp. System designs for medium and high power pulsed lamps typically include a lamp envelope, electrodes, and a surrounding cooling jacket. The lamp envelope is generally made of tubular material with adequate transparency for the desired spectral emission band(s) (e.g., UV-grade quartz for UV radiation), and filled with gases such as xenon, krypton, or other suitable gas(es). Electrodes are located in opposite ends of the tube, connected to the source of high voltage and current, and help to form an electrical discharge in the gas.

FIG. 1 illustrates an example of a pulsed (or flash) lamp design configuration (without pulsed power supply) such as may be utilized in materials processing applications that were once termed to be “medium” to “high” in power output range (i.e., prior to the latest applications that generally require a new generation of lamp design that delivers yet higher output power while simultaneously providing better performance and lifetime). The cross-sectional views show a cooling jacket 126 of suitably transparent material surrounding the circumference of the lamp envelope 122, thereby providing a volume 120 for circulation of cooling fluid (gas or liquid, typically de-ionized water) between the lamp envelope 122 exterior surfaces and the internal surface of the cooling jacket 126, providing removal of excess heat developed during the lamp operation. First high voltage electrical lead 134 and second high voltage electrical lead 136 are passed through some arrangement of mounting plate (or flange) 128, thereby providing connection to lamp cathode 124 and anode 138. In order to enhance the electrical high voltage breakdown and induce current flow between the electrodes, a typical method is to run the cathode 124 ground return current lead 140 along the lamp envelope 122 exterior. Cooling water inlet passage 130 and cooling water outlet passage 132 provide a means for removing heat transferred from the lamp envelope 122.

While there are many known styles and methods for operating pulsed flash lamps, it is most common for medium and high power pulsed flash lamp operation to include some version of each of the three typical electrical operating modes: an ignition mode, a simmer mode, and a pulse mode. The ignition mode provides the initial electrical breakdown and ionization of gas inside the tube by means of a special high voltage igniter circuit. Following ignition, the simmer (standby) mode provides a small current between the high power pulses and maintains a constant low level of gas ionization inside the tube, thereby maintaining a lower impedance electrical load at the onset of the main discharge pulse. The pulse mode is characterized by the production of a short, high peak power main discharge inside the tube, with durations ranging between microseconds and milliseconds, and with peak powers ranging from less than one to up to hundreds of megawatts. Once the lamp has been ignited and achieves simmer mode, it is usually intended that simmer is maintained throughout pulse mode operation until a cessation of pulse mode operation is desired.

All high power flash lamp modes consume electrical energy, and their output efficiency for any given process can vary widely. Heretofore typical flash lamp systems comprising the older “high” power generation of technology as exemplified in FIG. 1 rarely consume more than 5 or 6 kilowatts of energy, and therefore utilize pulsed power supply methods that are more or less based upon conventional techniques applied to lower power flash lamps. Most of the electrical energy is consumed by simmer current and high energy pulses.

The growing demand for increased processing power in many applications requires much improved flash lamp performance. In order to extend both power and performance capabilities beyond the level of typical and older generation of medium to high power flash lamps, new methods and equipment are required. For example, large-scale water disinfection and remediation is just one application whereby a new generation of higher power and performance PUV lamps is highly advantageous. In this setting, UV light can effectively disinfect across a broad range of targeted pathogens. In sharp contrast with chemical disinfectants such as chlorine, UV light can disinfect without adversely affecting the taste, odor, or safety of the water, and is particularly effective against protozoa, such as Cryptosporidium Parvum. Additionally, pulsed UV systems deliver UV light with neither the hazardous mercury, nor the explosive potential created by high lamp envelope temperatures and pressures that are inherent in conventional continuous wave (CW) medium pressure UV lamps. Furthermore, it is known that the CW mercury lamps (among others) have an inherent problem of performance degradation due to the thermal gradient-induced fouling (minerals attraction) of lamp cooling jackets.

As an example of one such new higher power and performance flash lamp optimized for PUV applications, the simmer current of a flash lamp with a diameter of 0.9 cm and are length of 100 cm can require energy of 1 kilowatt or more during high pulse repetition frequency operation. Each high energy discharge pulse, with duration of perhaps less than one up to several hundreds of microseconds, might require an additional 600 Joules or more of electrical energy. Since the regime of UV lamp operation might include pulse repetition frequencies up to 50 Hz (or more), there could be as much as 20-30 kilowatts of electrical power expended in order to deliver the highest power UV output from a single lamp.

As illustrated in FIG. 2, the design of this new generation of high power PUV lamp 200 has as one of its differentiating characteristics an arc length that is considerably longer than those utilized in lower power flash lamps, which typically encompass the range from 5 cm up to about 35 cm maximum arc length. By extending the arc length considerably beyond 35 cm, the energy deposited between the electrodes 208 is then spread out over a much larger area, thereby advantageously reducing the loading upon the lamp envelope wall 202 in terms of potentially damaging thermal and UV flux densities. Lamp cooling jacket 204 is designed so as to provide a relatively narrow annular passageway 210 for the cooling fluid along the length and circumference of the lamp 202, thereby enabling a relatively high linear flow rate with high turbulence and more efficient heat transfer. A suitably sealed and/or insulated electrical connection 206 to electrodes 208 provides a means for delivering pulsed electrical power to the lamp 200.

According to both theoretical calculations of and empirical data from pulsed flash lamp operation, high peak power pulses can easily produce plasma temperatures that exceed 10,000 K within the discharge of the electric arc. As the plasma temperature increases, the amount and overall percentage of shorter wavelength (e.g., ultraviolet) light output also increases. When the flash lamp application is UV processing, then it is desirable to somehow maximize the UV output efficiency of the lamp. Before now, this has generally been done by simply increasing the peak power of the pulse, yielding higher plasma temperatures and increased UV photon production. Unfortunately, such brute force techniques can result in a corresponding degradation of lamp lifetime and performance consistency. This is due to the increased average and peak energy loading within the lamp envelope, eventually accelerating the process of materials degradation and failure.

Most of the pulsed power techniques that have generally been applied to the art of high peak power flash lamp operation are based upon a standard LC single mesh pulse forming network (PFN) that delivers through the lamp a critically-damped current pulse with a near-Gaussian profile for the time-amplitude curve (FIG. 3a). The formation and establishment of plasma down the flash lamp bore actually presents a complex, dynamically changing load to the pulsed power supply. The issues surrounding and requirements of driving a particular current through such a time and power-varying impedance have most commonly and conveniently been understood within the context of and addressed by means of a simple LC pulse forming topology. Prior to the recent challenges presented by the new generation of very high power and performance pulsed UV lamps, such methods have been considered to work adequately for most applications. While adherence to this straight-forward and proven method has some advantages, it can also have some limitations in terms of electrical efficiency and lamp degradation. This is particularly important when the design goal is to produce more UV light without also increasing both the peak power input and visible/infrared light output. As further explained herein, an evaluation of the actual lamp electrical conditions throughout such a pulse (FIG. 3b) shows that during much of the LC PFN-derived pulse there is a poor impedance match between the lamp and the pulsed power supply/PFN. The optimum match occurs only near the peak of this pulse, which is the region wherein the peak power is sufficient for creating higher plasma temperatures that produce the most UV; the remainder of the energy is primarily lost in the form of visible light and thermal waste. Much of this wasted high power thermal energy becomes one of the dominant contributors to lamp performance degradation. It is therefore desirable and advantageous to solve this problem.

One solution is to create by one of several possible means a more effective impedance-match throughout the entire pulse, thereby providing the necessary conditions for maximizing UV output from the lamp, while simultaneously reducing stressful lifetime limiting factors. While some forms of impedance-matching techniques have been successfully utilized in so-called modulated CW, quasi-CW, and square pulse laser flash lamp applications (e.g., Square Pulse, Long Pulse, and High Charge-Transfer), these methods and devices are differentiated from those of the new generation of very high power and performance lamps by having the following characteristics very high duty cycles, very long pulses (milliseconds), lower peak power, and relatively low to medium average power levels. These existing methods and devices are entirely unsuitable in many high power UV processing applications, which require very low duty cycles (less than about two percent), very short pulses (microseconds), higher peak power (greater than about 1,000,000 Watts/pulse), and higher average power levels (greater than about 5,000 Watts input).

An additional problem source is the type of simmer mode that has universally been applied to the older generation of high peak power pulsed flash lamps. Some background information related to simmer issues is helpful in understanding these problems. It is known that the standard method of increasing the average power output of a pulsed electric discharge lamp is to increase the pulse repetition frequency; however this also increases the average internal temperature of the gas(es) and materials within the lamp. Assuming that the discharge is always created above the “higher pressure” side of the Paschen curve (virtually so with all commercially-available pulsed discharge lamps), as the average internal temperature-pressure increases, so does the average electrical impedance of the lamp, thereby creating yet another opportunity for increasing the mismatch of impedances between the pulsed power supply and the lamp. Post-discharge gas pressure excursions can subsequently create higher post-discharge lamp impedance excursions, thereby demanding that the simmer power be increased in order to prevent extinguishment of the simmer. See for example, U.S. Pat. No. 5,191,261. The problem with this method is that at some point of increasing pulse repetition frequency, the thermal dissipation effects within the lamp envelope from the combination of this additional simmer power, in addition to the increasing average discharge power, tends to require ever increasing amounts of simmer power input in order to force the post-discharge lamp impedance excursions into a safe, lower impedance region that will prevent quenching of the arc between pulses. The net result is a condition whereby the additional simmer power input used for temporarily reducing the lamp impedance between the pulses actually ends up contributing to a further increase in average lamp impedance, thereby increasing the effective impedance beyond that for which the lamp was designed (K₀) in order to achieve some specific plasma temperature. Subsequently, the lamp is no longer operating during the peak of the current pulse at the lowest impedance (Z₀) for which it and the pulsed power supply were designed to operate most efficiently and with integrity of performance In such a process, additional simmer power is expended in order to maintain high power pulsed lamp operation, while at the same time resulting in poorer lamp performance because the lamp is then no longer operating within the Z₀ regime for which it was designed. When applying the legacy simmer mode power techniques (used for the older generation of pulsed discharge lamps) to the new generation of high power pulsed lamps, the resulting performance is less efficient and generally a liability. It is therefore desirable and advantageous to solve the problems encountered during the application of both prior art and conventional simmer methods.

An additional simmer consideration is for those applications that require a low pulse repetition frequency (i.e., a low duty cycle) and a correspondingly rather long time between pulses. Under such conditions a topology that incorporates a continuous and high current simmer mode is not necessarily the best choice, because the simmer current power expenditure can comprise a much larger portion of the overall power consumption, thereby lowering overall electrical efficiency. However, in order to consider alternative techniques that could advantageously provide a non-continuous (i.e., pulsed) simmer current, new requirements must be placed upon the characteristics and performance of the ignition pulse, with which the open circuit lamp is “flashed over” by a high voltage pulse that initiates an electron current avalanche across the electrodes gap, quickly decreasing the impedance suitably low enough to then allow a stabilized simmer current between the electrodes.

During long-term, continuous and/or nearly continuous operation of high power pulsed discharge lamps, the application of the ignition pulse mode has typically been a rather infrequent occurrence because it is only utilized in order to initiate a simmer current in a “cold” flash lamp (i.e., one that is entirely “off” and electrically an open circuit). This has been for several seemingly good reasons. Virtually all such high peak and average power systems intentionally maintain a continuous simmer instead of quenching the lamp current between each and every pulse. As long as the lamp is already simmering, there is no need to “strike” the lamp with a very low current high voltage ignition pulse. Additionally, when applied to high peak and average power lamps, the various methods utilized for creating a suitable ignition pulse are a bit complicated, fragile, not suited for continuous high repetition rate operation, and tend to be detrimental to lamp electrode and envelope lifetime if applied very frequently. Since the work function of a thermionic dispenser cathode is partly a function of cathode temperature, any lamp operation method that allows lower-than-required cathode temperature excursions is likely to exhibit deleterious effects resulting from a subsequently less efficient charge transfer at the electrode surface. This is why the utilization of the so-called “pseudo simmer” technique, which applies an ignition pulse and subsequent simmer current prior to every main discharge pulse, has not been considered useful for high power and continuous operation (even low-rate) pulse repetition frequency (PRF) applications. None-the-less, the possibilities presented by the pseudo simmer method (e.g., reduced power/heat into the lamp and a more stable K₀ and Z₀) are both attractive and compelling if the technique could be applied in a manner that solves the aforementioned problems. It is advantageous to create a new, alternative simmer mode topology that provides the benefits possible with a pseudo simmer type of ignition operation, while also solving the problems of the inherent detriments that the existing pseudo simmer methods incur upon high peak and high average power pulsed electric discharge lamps.

This new generation of pulsed discharge lamps can be enabled by a unique ability to precisely configure the voltage and current pulse waveforms for the purpose of impedance match the varying load of the lamp throughout all three operating modes: ignition, simmer, and pulse. Furthermore, such precise impedance matching can advantageously be dynamically adjusted in real time on a pulse-to-pulse basis, according to the usual pulse condition variability encountered due to the combinations of process(es) requirements and effects from duty cycle, power input, thermodynamics, and lamp degradation.

In order to achieve these, and other advantages of the latest and highest power pulsed flash lamp systems, certain improvements beyond the prior art are required. The pulsed power supply methods utilized for the older generation of lower power and performance flash lamps are inadequate to the task; this invention provides necessary solutions.

Accordingly, a primary object of the present invention is to reduce and/or eliminate disadvantages of existing systems as mentioned above. In response to the need by the water industry for achieving the “Best Available” technology's highest levels of safety, accuracy, and efficiency, all which performance-based PUV disinfection systems can deliver, the present disclosure provides examples related to flash lamp pulsed power supply systems that are optimized for UV processing applications, and in particular, for water disinfection. However, it is understood by practitioners of the art that this invention and its various embodiments can be advantageously utilized across the entire range of possible high power flash lamp applications, and its implementation is not limited to any particular light output spectrum, process, or industry.

A further object of this invention is to provide a reliable and cost-effective pulsed discharge lamp power supply system that promotes PUV lamp efficiency beyond that which is achievable by means of prior art, thereby similarly decreasing the loss factor for both UV radiation and overall electrical energy.

A further object of this invention is to provide a pulsed discharge lamp power supply system that also serves to help prevent lamp envelope fracture and/or light output degradation resulting from the deleterious effects of intense radiation pulses.

A further object of this invention is to provide a pulsed discharge lamp power supply system that intelligently produces an ignition mode pulse only when and in the form specifically required for optimal lamp operation.

A further object of this invention is to provide a pulsed discharge lamp power supply system that intelligently produces a simmer current only when and in the form specifically required for optimal lamp operation.

A further object of this invention is to provide a pulsed discharge lamp power supply system that intelligently produces a main discharge current pulse only when and in the temporal-amplitude shape that is specifically required for optimal lamp operation.

A further object of this invention is to provide a pulsed discharge lamp power supply system that intelligently produces an electrical output that is dynamically impedance-matched with the lamp throughout the entire time span of and the transition sequence between all three operating modes, thereby creating the necessary discharge conditions for optimal lamp operation.

These and other objects are achieved in the present invention.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter which illustrate preferred embodiments of the invention.

### BRIEF DESCRIPTION OF THE DRAWINGS

FIG. 1 illustrates a typical previous generation medium to high power flash lamp geometry, including electrical leads layout.

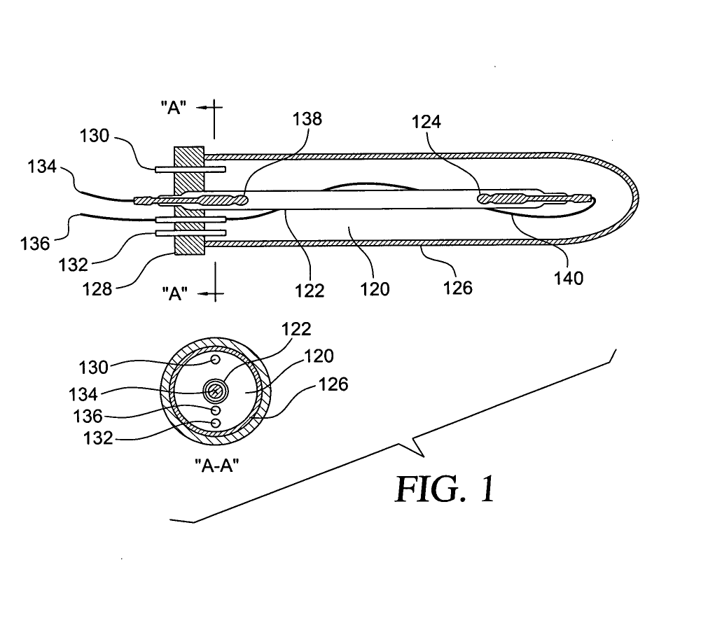

FIG. 2 illustrates an example of a new generation high power and performance flash lamp geometry, not including electrical leads layout.

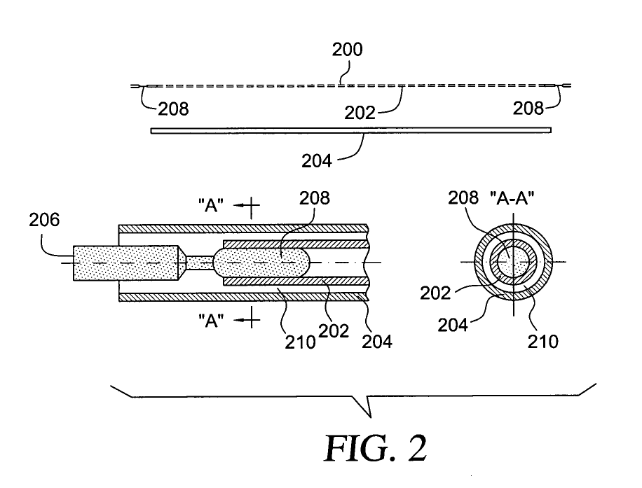

FIG. 3 illustrates a time-amplitude curve 3a that represents the main discharge pulse electrical current characteristics typical of a standard LC single mesh pulse forming network (PFN) utilized with conventional (lower power and performance) pulsed lamps, and 3b illustrates the generalized state of poor impedance match between the lamp and the pulsed power supply/PFN for conventional (lower power and performance) pulsed lamps.

FIG. 4 illustrates a semi-logarithmic scale example of the temporal and amplitude relationships among voltage, current, and impedance during the three operating modes typical to conventional (lower power and performance) pulsed lamps.

FIG. 5 illustrates examples of ignition mode to simmer mode transition waveforms typically exhibited by conventional “pseudo-simmer” methods.

FIG. 6 illustrates examples of ignition mode to simmer mode transition waveforms exhibited by a dynamically-matched impedance-optimized “igniter-simmer” method.

FIG. 7 illustrates example main discharge pulse waveforms that can be achieved by a new pulsed lamp method, termed “Neo-Pulse”.

FIG. 8 illustrates example pulse waveforms comprising the resulting combination sequence of “Igniter-Simmer” and “Neo-Pulse” modes of lamp operation.

### DETAILED DESCRIPTION OF THE PREFERRED EMBODIMENTS

In order to satisfy the above mentioned objectives, the present invention addresses issues including but not limited to: specific pulsed power problems regarding non-ideal impedance-matched electrical characteristics associated with the operation of the previous generation of pulsed lamp technology; necessary impedance conditions for ideal lamp electrical operation for the new generation of high power and performance pulsed lamps; methods by which each of the three typical pulsed lamp operating modes can be electrically optimized for better UV and electrical efficiency, thereby minimizing thermal stress upon crucial lamp materials; and methods by which the pulsed power supply output can be driven in order to produce the particular ideal and dynamically varying impedances throughout the three lamp operating modes (ignition, simmer, and pulse) of a lamp.

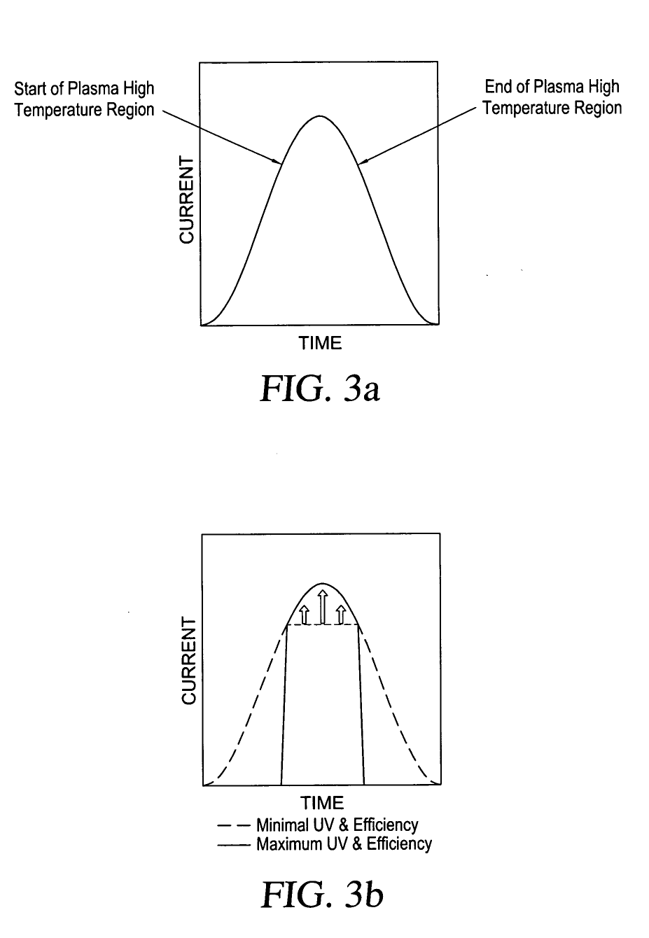

FIG. 3a illustrates a time-amplitude curve that represents the main discharge pulse electrical current characteristics typical of a standard LC single mesh pulse forming network (PFN) that is utilized with conventional (lower power and performance) pulsed lamps. It is known by those practiced in the art that the design of a pulsed lamp system requires the achievement of several targeted specifications that are suitable to the intended application. Spectral output depends upon lamp plasma temperature, which is in large part determined by the plasma electron current cross-sectional density, which subsequently determines the peak current requirement For example in many UV applications the peak current must be large enough to drive the plasma temperature to at least 10,000 K. The resulting specified peak current requirement, in conjunction with certain lamp physical and electrical characteristics, drives the design of the typical LC PFN, along with the design capacity of the Pulsed Power Supply (PPS). Note that the inherent characteristics of such a system produce a pulse shape that achieves its intended output only near the peak of the pulse, and that much of the energy expended in such pulses is wasted. This is because such energy produces predominantly lower peak power output in the form of radiation that not only might not be useful for the process, but is likely detrimental to the long-term operation and performance of the lamp. In some applications, this wasted energy could account for 30% to 50% of the total energy expended throughout the main discharge pulse 3b. Mitigating this deleterious effect is not only advantageous, but in certain applications also a requirement in order to achieve required levels of lamp performance.

FIG. 3b further illustrates the generalized state of poor impedance match between the lamp and the pulsed power supply/PFN for conventional (lower power and performance) pulsed lamps. A properly designed lamp/PPS combination requires that the targeted peak current level be achieved, and this will simultaneously correspond with the targeted lowest impedance condition, or Z₀. In general, only that portion of the current pulse comprising the maximum peak current is useful for the process; much of the remaining and lower peak power electrical energy is deposited in the system as undesirable thermal energy. By advantageously eliminating such undesirable energy, this invention creates conditions by which the overall lamp electrical efficiency is substantially increased to new levels that previously were considered not possible, in addition to dramatically reducing harmful stresses and thereby increasing lamp service lifetime.

It is known by practitioners of prior art that conventional pulse power techniques typically applied to the previous generation of lower power and performance pulsed lamps do not scale well enough to achieve power and performance levels required for the new generation of high performance pulsed lamps. Virtually all conventional medium-to-high power pulsed lamp systems require a Pulsed Power Supply that at a minimum must accommodate four basic functions in this order: reliably produce an ignition pulse that drops the “infinite” impedance of an “OFF” lamp to some suitable level of standby, or simmer, “ON” condition; when so commanded, commence pulse-mode operation at some desired pulse repetition frequency; for each pulse, deliver to the lamp the current pulse shape and amplitude required for the targeted plasma temperature and duration (i.e., light output spectral intensities and duration); and throughout any subsequent post-pulse perturbations, provide optimum lamp power conditions in order to establish each following required pulse. As taught by this invention, the new generation of higher power and performance pulsed lamps require the same PPS functions; however, these functions must be augmented with new, more demanding, and higher performance characteristics, which require new methods in order to deliver such performance. There exist multiple requirements beyond those that are possible with the prior art as practiced for the older generation of pulsed lamps. A more detailed explanation of the more subtle technical issues involving each of the three lamp operating modes follows.

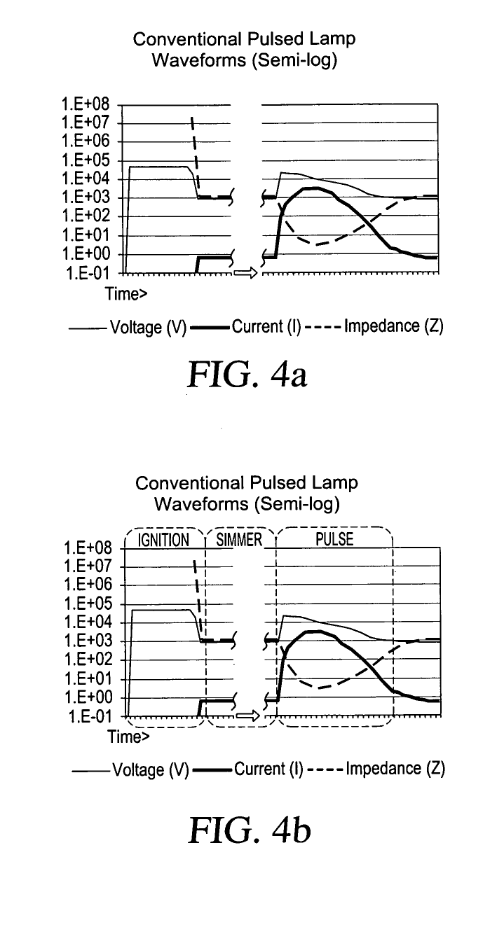

FIG. 4a illustrates a semi-log scale example of the temporal and amplitude relationships among voltage, current, and impedance during the three operating modes typical to conventional (lower power and performance) pulsed lamps. Note that these examples illustrate only relative and non-specific amplitudes and times, and are not intended to represent absolute values. As indicated, the time duration of the Simmer Mode can vary widely, depending upon the chosen pulse repetition frequency (PRF), the specific PPS design, and also whether or not the system is in “standby” (i.e., Simmer “ON”, PRF=0) or in “pulse operation” (i.e., PRF>0). Therefore, the Simmer Mode duration might be as short as many microseconds, to the usual milliseconds, or (if in “standby”) as long as many minutes. FIG. 4b outlines the temporal relationships among the said three operating modes for pulsed lamps: Ignition, Simmer, and Pulse. Here-to-for this invention, it has been standard for high power pulsed lamp systems to incorporate the general characteristics of these three modes, and in the following sequence: establish “Simmer Current ON” via an ignition pulse that allows ionization of the cold gases between the electrodes; when so commanded, trigger a main discharge pulse; following a “post-pulse” period of electrical and thermal reduction, resume for as long as desired the Simmer and Pulse sequence. Note that the Ignition mode is used only once for each session of pulse operation, and only in order to initially establish the Simmer, which is then always maintained “ON” between main discharge pulses. As described, this type of pulsed lamp operation method is typically termed “Simmer” (e.g., a “simmered flash lamp”).

An alternate type of pulsed lamp operation is termed the “pseudo-simmer” method. It is characterized by the general absence of simmer current following each main discharge pulse. Instead, there is a relatively long “OFF” time between subsequent pulses, and the simmer is then applied shortly prior to each main pulse. Of course, this then requires an ignition pulse in order to initiate simmer current before each and every pulse. Thus, the ignition pulse must be applied at the same pulse repetition frequency as the main pulse. When this method is applied to high pulse repetition frequency and high energy pulse (i.e., high power) systems, it is detrimental to lamp performance, and therefore, not useful for such applications.

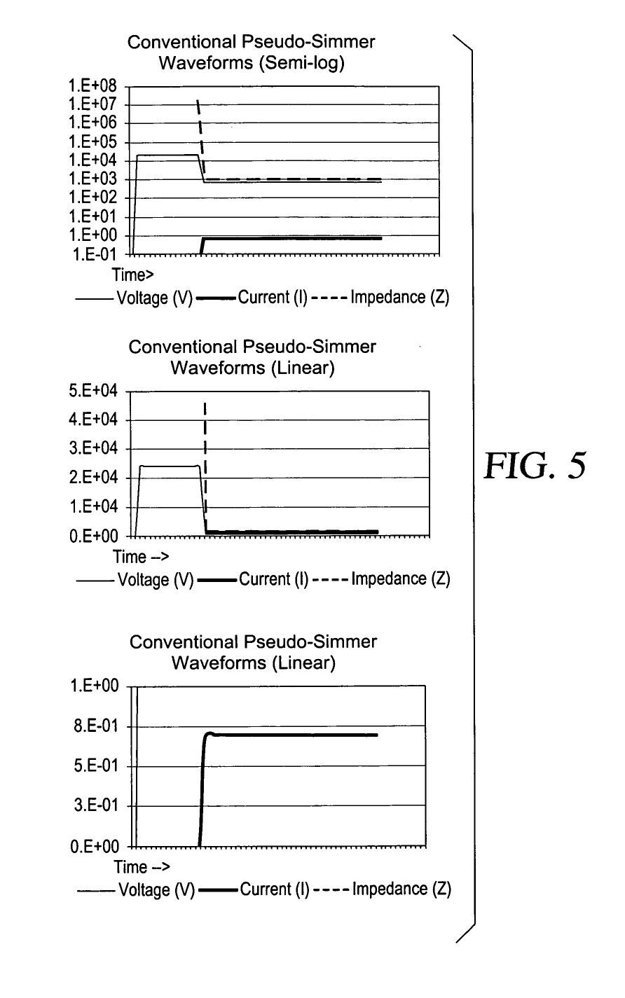

FIG. 5 illustrates examples of ignition mode to simmer mode transition waveforms typically exhibited by conventional “pseudo-simmer” methods. For the purpose of clarity, the main discharge pulse (pulse mode) that precedes the simmer is omitted from this illustration. The electric field from an “over-voltage” pulse, typically at an amplitude of about twice the voltage provided by the LC PFN at Z₀, eventually creates enough electron flow through the gas between the electrodes to rapidly drop the lamp impedance to some simmer level that is established by the current output limit set by the pulsed power supply (PPS). Note that the rate of current rise, along with the rate of lamp impedance change, is not intentionally limited by the PPS; neglecting power supply stiffness and parasitic Z, it is in an uncontrolled and immediate “free-fall” mode until it suddenly encounters the simmer current output limitation characteristic of the PPS design. Likewise, the resulting I²R thermal effect upon the originally “cold” electrodes is one that is very high rate of rise; more importantly, the occurrence of this thermal input is precisely coincident with the instant condition of full simmer current operation. This forces an essentially cold electrode to transfer currents at the interface between solid electrode and plasma.

Thermionic dispenser cathodes are used to lower the electron emitter work function on the surface of electrodes, such as are standard in pulsed lamps. Properly configured, such electrodes exhibit a vastly improved lifetime. This is largely due to the resulting reduced thermal stress and materials depletion upon electrode surfaces, which are the crucial physical and electrical interface for the transition between the solid and plasma states. In order for the electrode surface to achieve the desired emitter work function, some minimum temperature state must be induced so that the special emitter-enhancing materials embedded within the (usually) tungsten electrode are “boiled-off” and out onto the surface. Insufficient electrode temperatures, therefore, create low and insufficient electron emission, thereby causing thermal and physical damage to the electrode structure when the resulting abnormal, excessive-density current channels “crater” the surface, vaporizing electrode materials and creating deleterious deposition products.

When a pseudo-simmer topology is utilized, the simmer current is initiated through relatively cold electrodes that are subsequently easily damaged, albeit only a small amount per each ignition pulse. However, when extended into the scenario where it precedes each and every main discharge pulse of a desirably higher power and performance new generation pulsed lamp, the cumulative results are quickly damaging, and in the end, not acceptable. It is the very nature of the pseudo-simmer method's “uncontrolled” and very fast rate of rise of current that presents a practically cold electrode to the simmer current, and thus the crux of the problem for many applications.

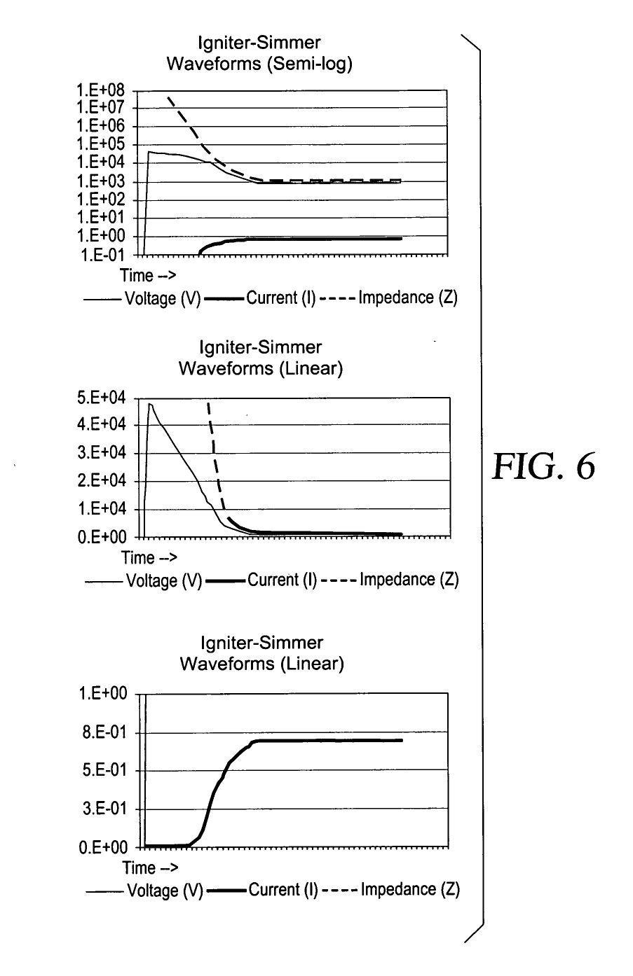

FIG. 6 illustrates examples of ignition mode to simmer mode transition waveforms exhibited by a dynamically-matched impedance-optimized “igniter-simmer” method of the present invention. The igniter-simmer method has several differentiating characteristics: the igniter mode initial voltage pulse is a very high rate of rise, and has the capability to achieve an amplitude of about four times the voltage provided by the LC PFN at Z₀; the “breakdown” and initial current occurs more quickly; and the rate of voltage and Z fall, and rise of current, are all relatively slow. By careful control of both the levels of and the rate of change in lamp impedance, an electrode can be “pre-warmed” to a required temperature before it then transfers higher levels of current, thereby overcoming the here-to-fore problem of rapid current onset through relatively cold, and thus, improperly functioning electrodes. In a further embodiment, by careful selection of the relationship between voltage and current levels, the resulting I²R thermal effect can be advantageously increased during the earliest period of very low current, thereby providing significantly more temperature increase at the most optimum time, which is prior to the onset of normal simmer current level. By this new “igniter-simmer” method, all the advantages of pseudo-simmer operation may be realized, while at the same time eliminating the inherent harmful effects that might otherwise prevent such implementation.

The igniter-simmer method illustrated in FIG. 6, has several differentiating characteristics relative to the pseudo-simmer method: the igniter mode initial voltage pulse is a very high rate of rise, having the capability to achieve an amplitude of about four times the optimum voltage V_{Z0} provided by the LC PFN at Z₀ and at a rate of at least 1.4 V_{Z0}/μsec; subsequently the breakdown and initial current occurs more quickly; and the rate of voltage and Z fall; and rise of current, being intentionally under control, are all relatively slower.

It is understood that for any given new generation pulsed lamp system design, the specific and perhaps unique set of pulsed lamp design specifications and operating characteristics will determine the igniter-simmer requirements. The optimum igniter-simmer design solution must include at least the following 5 major PPS parameters: igniter pulse voltage rise and amplitude; current inception, rise time, and amplitude; lamp impedance levels and rate of fall; the relative levels, changes, and timing of I²R thermal input; and the relative timing and amplitude relationships among the preceding 4 parameters. Additionally, the optimum igniter-simmer design solution must include the broad range of pulsed lamp design parameters that are common in the industry and well known to those who practice the art.

In order to achieve the advantages of igniter-simmer operation, it must be supported by electrical circuitry suitable for producing the required pulsed power conditions. Various methods are known by which both voltage and current—controlling power supplies may precisely and instantly control the power output into varying loads; such supply methods and derivations thereof might be utilized in applications requiring igniter-simmer devices and methods. The proper incorporation of this invention's igniter-simmer method into the capabilities and operation of such power supplies thereby enables unique and advantageous pulsed power performance capabilities that are required for the new generation of high power and performance pulsed lamps.

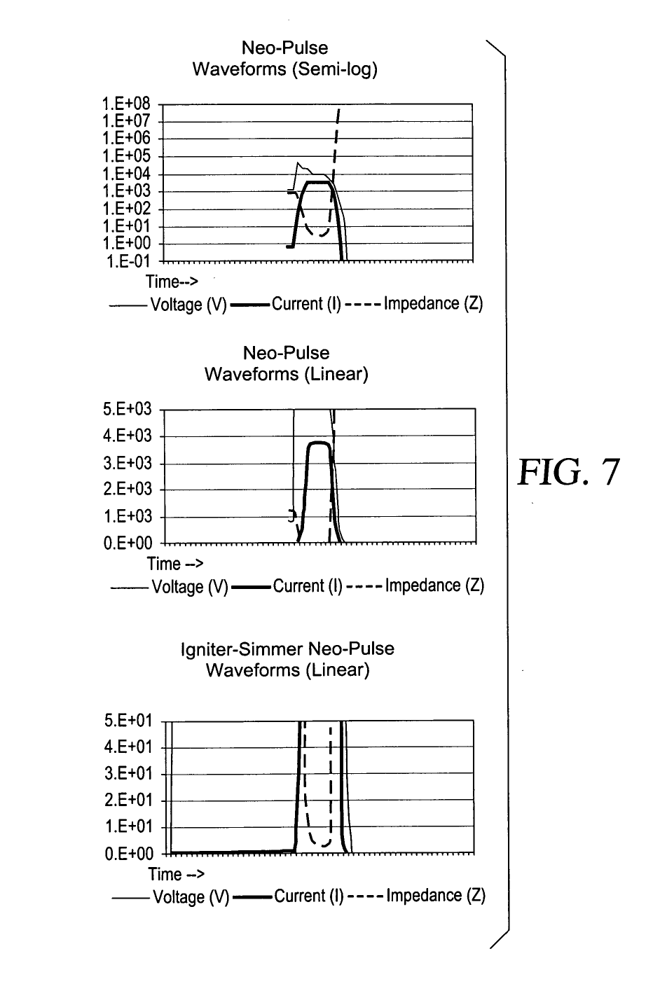

Having addressed both the problems and this invention's solutions regarding igniter and simmer methods, the aforementioned issues caused by a poorly impedance-matched main discharge pulse also require solutions. In order to create a main discharge pulse that achieves the required peak current and Z₀ without the relatively large electrical losses associated with the standard LC PFN method of driving pulsed lamps, this invention builds upon the novel characteristics and capabilities of the igniter-simmer PPS. By utilizing features of the dynamically-matched impedance-optimized igniter-simmer method, the pulse mode operation characteristics can be advantageously modified to exclude the electrical conditions that are determined to be wasteful, inefficient, and detrimental to pulsed lamp and overall system performance. FIG. 7 illustrates exemplary main discharge pulse waveforms that can be achieved by this new pulsed lamp method, herein termed “Neo-Pulse”. A suitable voltage and current-controllable PPS provides sufficient dynamic response for producing the exact desired lamp impedance across the temporal range of the pulse, thereby providing the unique ability to precisely design and achieve the ideal pulse characteristics for any particular application. This contrasts with the essentially fixed and non-ideal performance characteristics inherent with the conventional LC PFN-derived main discharge pulse that is utilized in the older generation of pulsed lamp technology. The semi-logarithmic scale waveforms 7a illustrate a complete Neo-Pulse, starting with the pre-existing electrical conditions created by the igniter-simmer mode operation. Differentiated from conventional pulse mode waveform 4b by the following general characteristics, the Neo-Pulse: pulse mode initial voltage has a very high rate of rise, and has the capability to achieve an amplitude of about four times the voltage provided by the LC PFN at Z₀; the current rate of rise is much higher, thereby quickly (and practically instantly) achieving the targeted peak current and spectral output; the pulse shape is more square, or “top-hat” in form; the subsequent rate of voltage and current fall, and rise of Z, are all relatively quick; and the end of the pulse terminates the power input into the lamp, essentially quenching any post-pulse simmer-mode operation. Linear scale waveforms 7b illustrate a more detailed view of an amplitude-scaled portion of the same Neo-Pulse, as does linear scale waveforms 7c, which shows in greater detail the lamp Z₀ portion.

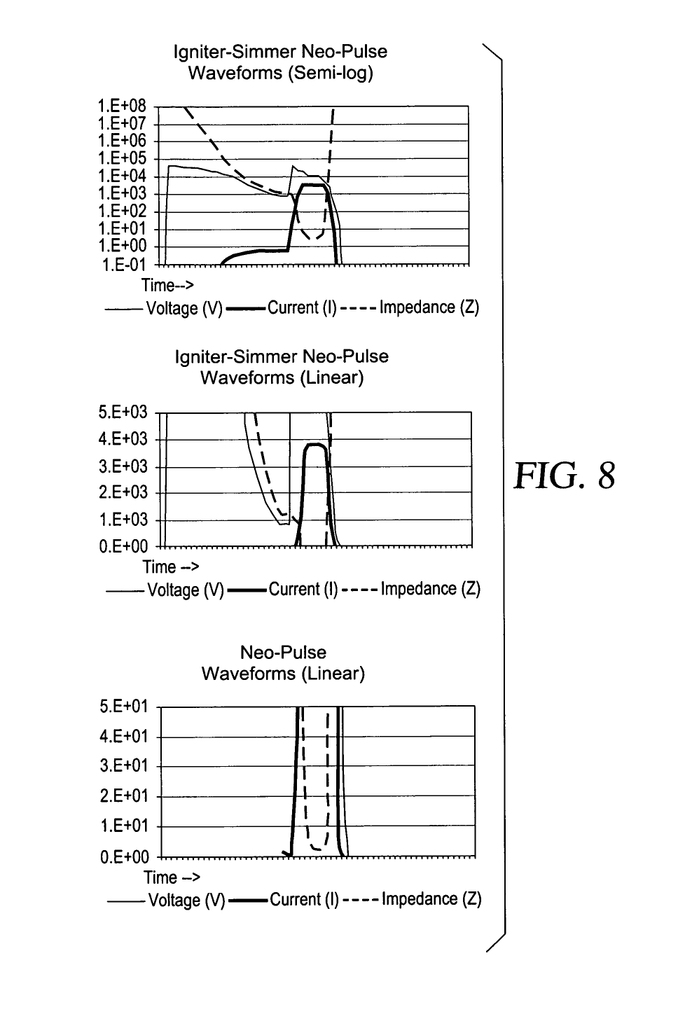

A solution to the inherent problems of a pseudo-simmered pulsed lamp operation topology is illustrated by the waveforms of FIG. 8, which show the resulting combination sequence of “Igniter-Simmer” and “Neo-Pulse”. In essence, the heretofore three conventional operating modes (ignition, simmer, and pulse) are seamlessly combined into a more capable and higher performance substitute (Neo-Pulse), which is an electrical pulse that is intelligently designed and actively controlled in order to create the optimum discharge conditions for the particular lamp system characteristics. Although this invention has broad applicability and is not limited as such, in particular it can be advantageously used for those applications where the advantages of the pseudo-simmer method are negated by its subsequent deleterious effects. The semi-logarithmic scale waveforms 8a illustrate a complete Igniter-Simmer Neo-Pulse, starting with the pre-existing of lamp “OFF”, which is one of the desirable characteristics of pseudo-simmered operation. The afore-mentioned descriptions and characteristics of both Igniter-Simmer and Neo-Pulse methods apply. Likewise, linear scale waveforms 8b illustrate a more detailed view of an amplitude-scaled portion of the same igniter-simmer Neo-Pulse, as does linear scale waveforms 8c, which shows in greater detail the lamp Z₀ portion. For simplicity, we shall henceforth term this operating mode combination of igniter-simmered Neo-Pulse as simply “Neo-Pulse”. In short, Neo-Pulsed lamp operation enables a new generation of higher power and performance pulsed lamps that was heretofore not achievable by means of either conventional LC PFN or pseudo-simmered operation topologies. Indeed, the output waveforms of the Neo-Pulse method may be configured to maintain simmer between pulses, thereby also advantageously improving output efficiency, performance, and lifetime when so utilized for an otherwise standard simmered lamp topology.

Regarding the means by which any Neo-Pulsed capable power supply may be designed, it is understood that there exists a broad range of possibilities available to those practiced in the art. For example, such means could include various forms and/or combinations of supplies, including but not limited to: solid-state power modulators; linear power; spark and rail-gap switched; magnetically-switched via saturable inductors; optically and/or electrically switched thyratrons and/or other tubes; and so forth. This invention is likewise not limited in scope to any particular pulsed power supply design approach by which the Neo-Pulse method may be incorporated.

Each reference referred to within this disclosure is herein incorporated in its respective entirety.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

What is claimed is:

1. A pulsed lamp power supply method comprising:
simultaneously monitoring and controlling at least one of voltage or current output amplitudes,
producing dynamic control of lamp impedance, and
accommodating needed temporal and amplitude combinations of voltage, current, and lamp impedance to achieve predetermined conditions for operating mode.

2. The method of claim 1, wherein said accommodating is done in real time.

3. The method of claim 1, wherein said operating mode is ignition, simmer, pulse, or combinations thereof.

4. The method of claim 3, said predetermined conditions comprising:
in said ignition mode, a means to achieve greater or equal to 20 kV/μsec of rise-time to a peak voltage that is approximately a factor of four (4) times the voltage requirement to achieve the targeted peak current amplitude for the lamp Z₀;
a controlled rate of current rise and lamp impedance reduction producing a gradual transition between said ignition mode and said simmer mode;
a controlled I²R-induced thermal rise to electrodes preceding the onset of said simmer mode;
a means to increase I²R-induced temperature;
a “pre-warmed” condition to electrodes prior to full simmer current level; and
a means to immediately terminate or extinguish the lamp current.

5. The method of claim 4, wherein said I²R-induced thermal rise is mediated via dynamic control of lamp impedance.

6. The method of claim 3, wherein said operating mode is simmer, said predetermined conditions comprising:
controlled levels and rates of change in voltage and current;
a means to change I²R-induced temperature at any current level;
a pre-set electrode temperature; and
a means to terminate or extinguish the lamp current.

7. The method of claim 6, wherein said I²R-induced change is mediated via dynamic control of lamp impedance.

8. The method of claim 3, wherein said operating mode is pulse mode, said predetermined conditions comprising:
a means to achieve greater or equal to 20 kV/μsec of rise-time to a peak voltage that is approximately a factor of four (4) times the voltage requirement to achieve the targeted peak current amplitude for the lamp Z₀;
controlled levels and rates of change in voltage and current;
a means to change I²R-induced temperature at any current level;
a dynamically-assisted control of electrode temperature; and
a means to terminate or extinguish the lamp current.

9. The method of claim 8, wherein said I²R-induced change is mediated via dynamic control of lamp impedance.

10. The method of claim 3 further comprising
in said ignition mode, a means to achieve greater or equal to 20 kV/μsec of rise-time to a peak voltage that is approximately a factor of four (4) times the voltage requirement to achieve the targeted peak current amplitude for the lamp Z₀;
a controlled rate of current rise and lamp impedance reduction producing a gradual transition between said Ignition Mode and said Simmer Mode;
a controlled I²R-induced thermal rise to electrodes preceding the onset of said Simmer Mode;
in said ignition mode, the capability to intentionally force an increase in I²R-induced temperature;
a “pre-warmed” condition to electrodes prior to full simmer current level; and
in said ignition mode, the capability to immediately terminate or extinguish the lamp current; and
said necessary conditions for said simmer operating mode comprising:
controlled levels and rates of change in voltage and current;
a means to intentionally force changes in I²R-induced temperature at any current level;
a pre-set electrode temperature; and
a mean to immediately terminate or extinguish the lamp current; and
said necessary conditions for said pulse operating mode comprising:
the capability to achieve greater or equal to 20 kV/μsec of rise-time to a peak voltage that is about a factor of four (4) times the voltage requirement to achieve the targeted peak current amplitude for the lamp Z₀;
controlled levels and rates of change in voltage and current;
a means to change I²R-induced temperature at any current level;
a dynamically-assisted control of electrode temperature; and
a means to terminate or extinguish the lamp current.

11. The method of claim 10, wherein said ignition mode, said simmer mode, and said pulse modes are combined as a Neo-Pulse into any dynamically-varying electrical pulse shape as required in real time to accommodate shifting and/or varying lamp operating characteristics.

12. A lamp power supply system for a lamp comprising:
an electrical output, wherein said lamp transitions between operating modes, each said operating modes having preferred discharge conditions and wherein said electrical output is impedance matched with said lamp at each said operating mode.

13. A method for operating a pulsed flash lamp comprising:
initiating a pre-warming phase, said pre-warming phase comprising pre-warming electrode(s) using a first current level to a pre-designated temperature; and
transferring a second current level to said electrode(s), wherein said second current level is higher than said first current level.

14. The method of claim 13, wherein said pre-warming is mediated by controlling levels of and rate of change in pulsed flash lamp impedance.

15. The method of claim 13, said pre-warming phase further comprising: increasing I²R thermal effect.

16. The method of claim 15, said increasing I²R thermal effect comprising controlling voltage and thermal levels.

17. The method of claim 4, said necessary conditions further comprising:
a means to achieve at least 1.4 V_{Z0}/μsec of rise time to a peak voltage that is about a factor of four (4) times the voltage requirement to achieve the targeted peak current amplitude for the lamp Z₀.

18. The method of claim 8, said predetermined conditions further comprising:
a means to achieve at least 1.4 V_{Z0}/μsec of rise time to a peak voltage that is about a factor of four (4) times the voltage requirement to achieve the targeted peak current amplitude for the lamp Z₀.

19. A pulsed discharge lamp power supply system comprising an electrical output wherein said electrical output is dynamically impedance-matched with a lamp throughout each operating mode, said operating modes comprising ignition, simmer, or pulse and related transitions.

20. The lamp power supply system of claim 19, further comprising:
duty cycles less than two percent;
microsecond pulses;
peak power greater than 1,000,000 watts/pulse; and
average power levels greater than 5,000 Watts input.
